(19) United States
(12) Patent Application Publication
(10) Pub. No.: US 2026/0291415 A1
(43) Pub. Date: Sep. 24, 2026

(54) CONTROL DEVICE

(71) Applicants: Kabushiki Kaisha Toshiba, Kawasaki-shi (JP); Toshiba Electronic Devices & Storage Corporation, Kawasaki-shi (JP)

(72) Inventors: Ryusei MASUDA, Koto Tokyo (JP); Hiroshi OTA, Misato Saitama (JP); Hitoshi IMI, Yokohama Kanagawa (JP)

(21) Appl. No.: 19/367,122

(22) Filed: Oct. 23, 2025

(30) Foreign Application Priority Data
Mar. 18, 2025 (JP) 2025-043160

(51) Int. Cl. H02P 21/00; H02P 21/05; H02P 21/18; H02P 21/20; H02P 21/22

(52) U.S. Cl. CPC H02P 21/0003; H02P 21/18; H02P 21/20; H02P 21/22; H02P 21/05

(57) ABSTRACT

A control device includes an inverter, a modulator, a current sensor, a vector controller, a carrier controller, and a gain controller. Then inverter converts a DC voltage to an AC voltage. The modulator generates a pulse width modulation signal based on a phase voltage command value and a carrier wave. The current sensor detects a current flowing in the motor. The vector controller controls the phase voltage command value such that a d-axis current and a q-axis current match a command value based on an output signal of the current sensor. The carrier controller controls a carrier frequency such that a total loss of a loss of the inverter and a loss of the motor is minimized based on the d-axis current, the q-axis current, and an electrical angular velocity of the motor. The gain controller controls a control gain used for PI control based on the carrier frequency.

### CROSS-REFERENCE TO RELATED APPLICATION

Priority is claimed on Japanese Patent Application No. 2025-043160, filed Mar. 18, 2025, the content of which is incorporated herein by reference.

### FIELD

An embodiment of the present invention relates to a control device.

### BACKGROUND

In general, a carrier frequency of pulse width modulation (PWM) control is often handled as a fixed value and is set to about several kHz to several tens of kHz in an empirical rule. However, since a loss of a motor varies according to state variables, a carrier frequency with maximum efficiency is not present as a fixed value.

### BRIEF DESCRIPTION OF THE DRAWINGS

FIG. 1 is a functional block diagram showing functions of a control device according to an embodiment.

FIG. 2 is a block diagram showing an example of a current feedback control system associated with a d-axis current.

FIG. 3 is a block diagram showing an example of a current feedback control system associated with a q-axis current.

FIG. 4 is a block diagram showing an example of a speed feedback control system.

FIG. 5 is a block diagram showing a position controller.

### DETAILED DESCRIPTION

A control device according to an embodiment is a control device that controls a motor and includes an inverter, a modulator, a current sensor, a vector controller, a carrier controller, and a gain controller. The inverter converts a DC voltage to an AC voltage and outputs the AC voltage to the motor. The modulator generates a pulse width modulation signal for controlling switches included in the inverter based on a phase voltage command value and a carrier wave. The current sensor detects a current flowing in the motor. The vector controller controls the phase voltage command value such that a d-axis current and a q-axis current match a command value based on an output signal of the current sensor. The carrier controller controls a carrier frequency which is a frequency of the carrier waves such that a total loss of a loss of the inverter and a loss of the motor is minimized based on the d-axis current, the q-axis current, and an electrical angular velocity of the motor. The gain controller controls a control gain which is used in PI control performed by the vector controller and a control period which is a period in which the PI control is performed based on the carrier frequency.

Hereinafter, a control device according to an embodiment will be described with reference to the accompanying drawings.

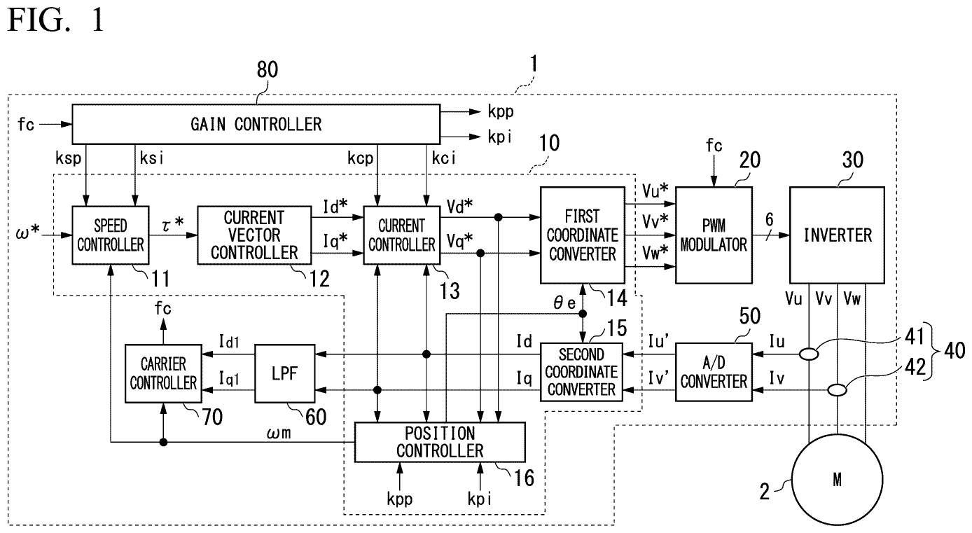

FIG. 1 is a functional block diagram showing functions of a control device 1 according to an embodiment. As shown in FIG. 1, the control device 1 controls a motor 2. For example, the motor 2 is a three-phase synchronous motor. The control device 1 includes a vector controller 10, a PWM modulator 20, an inverter 30, a current sensor 40, an A/D converter 50, a low-pass filter (LPF) 60, a carrier controller 70, and a gain controller 80 as functional blocks.

Functions of the control device 1 indicated by these functional blocks may be functions which are realized by hardware or may be functions which are realized by causing one or more processors to execute a program. Alternatively, the functions of the control device 1 may be functions which are cooperatively realized by hardware and software. Here, at least the inverter 30, the current sensor 40, and the A/D converter 50 are functions which are realized by hardware.

The inverter 30 converts a DC voltage to an AC voltage and outputs the AC voltage to the motor 2. The PWM modulator 20 generates a pulse width modulation signal for controlling switches included in the inverter 30 based on a phase voltage command value and carrier waves. The current sensor 40 detects a current flowing in the motor 2. The vector controller 10 controls the phase voltage command value such that a d-axis current and a q-axis current match command values based on an output signal of the current sensor 40. The carrier controller 70 controls a carrier frequency which is a frequency of carrier waves such that a total loss of a loss of the inverter 30 and a loss of the motor 2 is minimized based on the d-axis current, the q-axis current, and an electrical angular velocity of the motor 2. The gain controller 80 controls a control gain which is used for PI control performed by the vector controller 10 and a control period in which PI control is performed based on the carrier frequency.

The vector controller 10 includes a speed controller 11, a current vector controller 12, a current controller 13, a first coordinate converter 14, a second coordinate converter 15, and a position controller 16.

An angular velocity command value ω*, a machine angular velocity ωₘ output from the position controller 16, and a speed proportional gain kₛₚ and a speed integral gain kₛᵢ output from the gain controller 80 are input to the speed controller 11. The machine angular velocity ωₘ is an angular velocity of a machine angle of the motor 2. The speed controller 11 calculates a torque command value τ* with which a difference between the angular velocity command value ω* and the machine angular velocity ωₘ is zero by performing first PI control based on the angular velocity command value ω*, the machine angular velocity ωₘ, the speed proportional gain kₛₚ, and the speed integral gain kₛᵢ. The speed controller 11 outputs the torque command value τ* to the current vector controller 12.

The current vector controller 12 calculates a d-axis current command value Id* and a q-axis current command value Iq* based on the torque command value τ* input from the speed controller 11. The current vector controller 12 outputs the d-axis current command value Id* and the q-axis current command value Iq* to the current controller 13.

The d-axis current command value Id* and the q-axis current command value Iq* output from the current vector controller 12, a d-axis current Id and a q-axis current Iq output from the second coordinate converter 15, and a current proportional gain k_{cp} and a current integral gain k_{ci} output from the gain controller 80 are input to the current controller 13. The current controller 13 calculates a d-axis voltage command value Vd* with which a difference between the d-axis current command value Id and the d-axis current Id is zero and a q-axis voltage command value Vq* with which a difference between the q-axis current command value Iq* and the q-axis current Iq is zero by performing second PI control based on the d-axis current command value Id*, the q-axis current command value Iq*, the d-axis current Id, the q-axis current Iq, the current proportional gain k_{cp}, and the current integral gain k_{ci}. The current controller 13 outputs the d-axis voltage command value Vd* and the q-axis voltage command value Vq* to the first coordinate converter 14 and the position controller 16.

The d-axis voltage command value Vd* and the q-axis voltage command value Vq* output from the current controller 13 and a rotation angle θₑ output from the position controller 16 are input to the first coordinate converter 14. The rotation angle θₑ is a rotation angle of the motor 2 and is expressed as an electrical angle. The first coordinate converter 14 calculates a three-phase voltage command value by performing first coordinate conversion based on the d-axis voltage command value Vd*, the q-axis voltage command value Vq*, and the rotation angle θₑ.

Specifically, the first coordinate converter 14 converts the d-axis voltage command value Vd* and the q-axis voltage command value Vq* in a rotary coordinate system to a first voltage command value Va and a second voltage command value Vβ in a fixed coordinate system by performing reverse Park conversion based on the d-axis voltage command value Vd*, the q-axis voltage command value Vq*, and the rotation angle θₑ. The first coordinate converter 14 further calculates three-phase voltage command values by performing spatial vector conversion based on the first voltage command value Vα and the second voltage command value Vβ. The three-phase voltage command values include a U-phase voltage command value Vu*, a V-phase voltage command value Vv*, and a W-phase voltage command value Vw*. The first coordinate converter 14 outputs the three-phase voltage command values to the PWM modulator 20.

The three-phase voltage command values output from the first coordinate converter 14 and a carrier frequency f_{c} output from the carrier controller 70 are input to the PWM modulator 20. The PWM modulator 20 generates a carrier wave of the same frequency as the carrier frequency f_{c}. For example, the carrier wave is a triangular wave. The PWM modulator 20 generates six gate control signals which have been modulated in pulse width based on the three-phase voltage command values and the carrier wave. The PWM modulator 20 outputs the six gate control signals to the inverter 30. The gate control signals are an example of pulse width modulation signals.

For example, when an instantaneous value of the carrier wave is less than the U-phase voltage command value Vu*, the PWM modulator 20 generates a first gate control signal of a high level. When an instantaneous value of the carrier wave is equal to or greater than the U-phase voltage command value Vu*, the PWM modulator 20 generates the first gate control signal of a low level. The first gate control signal is a signal for controlling a gate of a U-phase high-side switch included in the inverter 30. The PWM modulator 20 generates a second gate control signal which is a complementary signal of the first gate control signal. The second gate control signal is a signal for controlling a gate of a U-phase low-side switch included in the inverter 30.

For example, when an instantaneous value of the carrier wave is less than the V-phase voltage command value Vv*, the PWM modulator 20 generates a third gate control signal of a high level. When an instantaneous value of the carrier wave is equal to or greater than the V-phase voltage command value Vv*, the PWM modulator 20 generates the third gate control signal of a low level. The third gate control signal is a signal for controlling a gate of a V-phase high-side switch included in the inverter 30. The PWM modulator 20 generates a fourth gate control signal which is a complementary signal of the third gate control signal. The fourth gate control signal is a signal for controlling a gate of a V-phase low-side switch included in the inverter 30.

For example, when an instantaneous value of the carrier wave is less than the W-phase voltage command value Vw*, the PWM modulator 20 generates a fifth gate control signal of a high level. When an instantaneous value of the carrier wave is equal to or greater than the W-phase voltage command value Vw*, the PWM modulator 20 generates the fifth gate control signal of a low level. The fifth gate control signal is a signal for controlling a gate of a W-phase high-side switch included in the inverter 30. The PWM modulator 20 generates a sixth gate control signal which is a complementary signal of the fifth gate control signal. The sixth gate control signal is a signal for controlling a gate of a W-phase low-side switch included in the inverter 30.

Six gate control signals output from the PWM modulator 20 and a DC voltage output from a DC power supply which is not illustrated are input to the inverter 30. The inverter 30 converts the DC voltage to three-phase AC voltages based on the sixth gate control signals. For example, the inverter 30 includes a three-phase full-bridge circuit including six switches. The inverter 30 includes the U-phase high-side switch, the U-phase low-side switch, the V-phase high-side switch, the V-phase low-side switch, the W-phase high-side switch, and the W-phase low-side switch as the switches constituting a three-phase full-bridge circuit. For example, the switches constituting a three-phase full-bridge circuit are MOS-FETs. The configuration of this three-phase full-bridge circuit is generally known, and thus illustration thereof will be omitted.

Although not illustrated, the inverter 30 includes gate driver formed of a semiconductor IC chip. The six gate control signals are input to the gate driver. The gate driver has a function of converting voltage values of the gate control signals to values capable of driving the gates of the switches included in the three-phase full-bridge circuit. The first gate control signal is supplied to the gate of the U-phase high-side switch via the gate driver. The second gate control signal is supplied to the gate of the U-phase low-side switch via the gate driver. The third gate control signal is supplied to the gate of the V-phase high-side switch via the gate driver. The fourth gate control signal is supplied to the gate of the V-phase low-side switch via the gate driver. The fifth gate control signal is supplied to the gate of the W-phase high-side switch via the gate driver. The sixth gate control signal is supplied to the gate of the W-phase low-side switch via the gate driver.

States of six switches included in the three-phase full-bridge circuit are controlled to an ON state or an OFF state according to levels of the gate control signals corresponding thereto, whereby the DC voltage is converted to three-phase AC voltages. The inverter 30 outputs the three-phase AC voltages to the motor 2. The three-phase AC voltages include a U-phase voltage Vu, a V-phase voltage Vv, and a W-phase voltage Vw.

The current sensor 40 includes a first current sensor 41 and a second current sensor 42. The first current sensor 41 detects a U-phase current Iu which is a current flowing in the U phase of the motor 2 and outputs a first voltage signal indicating a detection result of the U-phase current Iu to the A/D converter 50. The second current sensor 42 detects a V-phase current Iv which is a current flowing in the V phase of the motor 2 and outputs a second voltage signal indicating a detection result of the V-phase current Iv to the A/D converter 50. For example, the first current sensor 41 and the second current sensor 42 are current transformers.

The A/D converter 50 converts the output signal of the current sensor 40 to a digital value. That is, the A/D converter 50 converts the first voltage signal output from the first current sensor 41 and the second voltage signal output from the second current sensor 42 to digital values. The A/D converter 50 generates a U-phase current measured value Iu′ by converting the first voltage signal to a digital value. The A/D converter 50 generates a V-phase current measured value Iv′ by converting the second voltage signal to a digital value. The A/D converter 50 outputs the U-phase current measured value Iu′ and the V-phase current measured value Iv′ to the second coordinate converter 15.

The U-phase current measured value Iu′ and the V-phase current measured value Iv′ output from the A/D converter 50 and the rotation angle θₑ output from the position controller 16 are input to the second coordinate converter 15. The second coordinate converter 15 calculates a d-axis current Id and a q-axis current Iq by performing second coordinate conversion based on the output signal of the current sensor 40 and the rotation angle θₑ.

Specifically, the second coordinate converter 15 converts the U-phase current measured value Iu′ and the V-phase current measured value Iv′ to a first current measured value Iα and a second current measured value Iβ in a fixed coordinate system by performing Clark conversion based on the U-phase current measured value Iu′ and the V-phase current measured value Iv′. The second coordinate converter 15 converts the first current measured value Iα and the second current measured value Iβ in the fixed coordinate system to a d-axis current Id and a q-axis current Iq in a rotary coordinate system by performing Park conversion based on the first current measured value Ix, the second current measured value Iβ, and the rotation angle θₑ. The second coordinate converter 15 outputs the d-axis current Id and the q-axis current Iq to the current controller 13, the position controller 16, and the LPF 60.

The d-axis voltage command value Vd* and the q-axis voltage command value Vq* output from the current controller 13, the d-axis current Id and the q-axis current Iq output from the second coordinate converter 15, and a position proportional gain kₚₚ and a position integral gain kₚᵢ output from the gain controller 80 are input to the position controller 16. The position controller 16 calculates a machine angular velocity ωₘ and a rotation angle θₑ by performing third PI control based on the d-axis voltage command value Vd*, the q-axis voltage command value Vq*, the d-axis current Id, the q-axis current Iq, the position proportional gain kₚₚ, and the position integral gain kₚᵢ. The position controller 16 outputs the machine angular velocity ωₘ to the speed controller 11 and the carrier controller 70. The position controller 16 outputs the rotation angle θₑ to the first coordinate converter 14 and the second coordinate converter 15.

The LPF 60 is a digital low-pass filter configured to extract fundamental wave components of the d-axis current Id and the q-axis current Iq input from the second coordinate converter 15. The LPF 60 outputs the d-axis basic current I_{d1} which is a fundamental wave component of the d-axis current Id to the carrier controller 70. The LPF 60 outputs a q-axis basic current I_{q1} which is a fundamental wave component of the q-axis current Iq to the carrier controller 70.

The machine angular velocity ωₘ output from the position controller 16 and the d-axis basic current I_{d1} and the q-axis basic current I_{q1} output from the LPF 60 are input to the carrier controller 70. The carrier controller 70 calculates a carrier frequency f_{c} with which a total loss Pₐₗₗ of a loss of the inverter 30 and a loss of the motor 2 is minimized based on the d-axis basic current I_{d1}, the q-axis basic current I_{q1}, and the electrical angular velocity ωₑ of the motor 2. The carrier controller 70 calculates the electrical angular velocity ωₑ by multiplying the machine angular velocity ωₘ by a predetermined coefficient. The carrier controller 70 may calculate the electrical angular velocity ωₑ by multiplying the angular velocity command value ω* by a predetermined coefficient.

For example, the loss of the inverter 30 includes an on-resistance loss Pₒₙ, a switching loss P_{sw}, a shunt-resistance loss Pₛₕ, a gate-charge loss P_{gate}, and a dead-time loss P_{dead}. The loss of the motor 2 includes a copper loss W_{c} and an iron loss Wᵢ.

The on-resistance loss Pₒₙ is expressed by Expression (1). In Expression (1), Rₒₙ is an on-resistance of a switch included in the inverter 30, Iₑ is an effective value of a phase current, and D is a duty ratio. For example, the duty ratio D is 0.5. The effective value Iₑ of a phase current is a function of the carrier frequency f_{c}. Details of the effective value Iₑ of a phase current will be described later.

$${P}_{on} = 6 {R}_{on} {I}_{e}^{2} D \qquad ( 1 )$$

The switching loss P_{sw} is expressed by Expression (2). In Expression (2), Vas is a drain-source voltage of a switch included in the inverter 30, tᵣ is a rising time (an ascent time) of a switch included in the inverter 30, and t_{f} is a falling time (a descent time) of a switch included in the inverter 30.

$${P}_{sw} = {V}_{ds} {I}_{e} ( {t}_{r} + {t}_{f} ) {f}_{c} \qquad ( 2 )$$

The shunt-resistance loss Pₛₕ is expressed by Expression (3). In Expression (3), Rₛ is a resistance value of a shunt resistive element included in the inverter 30.

$${P}_{sh} = 3 {R}_{s} {I}_{e}^{2} D \qquad ( 3 )$$

The gate-charge loss P_{gate} is expressed by Expression (4). In Expression (4), Q_{g} is a gate charge of a switch included in the inverter 30, and V_{dr} is an output voltage of a gate driver included in the inverter 30. In other words, V_{dr} is a voltage which is applied to the gate of the switch when the switch included in the inverter 30 is turned on.

$${P}_{gate} = 6 {Q}_{g} {V}_{dr} {f}_{c} \qquad ( 4 )$$

The dead-time loss P_{dead} is expressed by Expression (5). In Expression (5), V_{f} is a forward voltage of a body diode which is parasitic in a switch included in the inverter 30, and t_{dead} is a dead time.

$${P}_{dead} = 6 {V}_{f} {I}_{e} {t}_{dead} {f}_{c} \qquad ( 5 )$$

The copper loss W_{c} is expressed by Expression (6). In Expression (6), Rₐ is a winding resistance of the motor 2.

$${W}_{c} = 3 {I}_{e}^{2} {R}_{a} \qquad ( 6 )$$

The iron loss Wᵢ is expressed by Expression (7). In Expression (7), Rₑ is an equivalent iron-loss resistance of an eddy-current loss, Rₕ is an equivalent iron-loss resistance of a hysteresis loss, and ψₑ is an effective value of an interlinkage magnetic flux. The effective value ψₑ of an interlinkage magnetic flux is a function of an effective value Iₑ of a phase current. That is, the effective value ψₑ of an interlinkage magnetic flux is a function of the carrier frequency f_{c}.

$${W}_{i} = \frac{{ω}_{e}^{2} {ψ}_{e}^{2}}{{R}_{e}} + \frac{{ψ}_{e}^{2}}{2 {f}_{c} {R}_{h}} \qquad ( 7 )$$

In consideration of Expressions (1) to (7), the total loss Pₐₗₗ of the loss of the inverter 30 and the loss of the motor 2 is expressed by Expression (8).

$${P}_{all} = {P}_{on} + {P}_{sw} + {P}_{sh} + {P}_{gate} + {P}_{dead} + {W}_{c} + {W}_{i} = 6 {R}_{on} {I}_{e}^{2} D + {V}_{ds} {I}_{e} ( {t}_{r} + {t}_{f} ) {f}_{c} + 3 {R}_{s} {I}_{e}^{2} D + 6 {Q}_{g} {V}_{dr} {f}_{c} + 6 {V}_{f} {I}_{e} {t}_{dead} {f}_{c} + 3 {I}_{e}^{2} {R}_{a} + \frac{{ω}_{e}^{2} {ψ}_{e}^{2}}{{R}_{e}} + \frac{{ψ}_{e}^{2}}{2 {f}_{c} {R}_{h}} \qquad ( 8 )$$

The effective value Iₑ of a phase current is expressed by Expression (9). In Expression (9), I_{bs} is a fundamental wave component included in a phase current, and Iᵣₚ is a current ripple component included in a phase current.

$${I}_{e} = \sqrt{\frac{{ω}_{e}}{2 π} {\int }_{0}^{2 π / {ω}_{e}} {\{ {I}_{bs} + {I}_{rp} \}}^{2} dt} \qquad ( 9 )$$

The fundamental wave component I_{bs} is expressed by Expression (10). In Expression (10), Iₘ is the amplitude of the fundamental wave component, which is expressed by Expression (11). As expressed in Expression (11), the amplitude Iₘ of the fundamental wave component is expressed by a square root of sum-of-squares of the d-axis basic current I_{d1} and the q-axis basic current I_{q1}.

$${I}_{bs} = {I}_{m} sin {ω}_{e} t \qquad ( 10 )$$

$${I}_{m} = \sqrt{{I}_{d 1}^{2} + {I}_{q 1}^{2}} \qquad ( 11 )$$

The current ripple component Iᵣₚ is expressed by Expression (12). In Expression (12), I_{c} is the amplitude of the current ripple component, which is expressed by Expression (13). In Expression (13), D is a duty ratio and is, for example, 0.5. In Expression (13), V_{dc} is a source voltage of the inverter 30, that is, a DC voltage which is supplied to the inverter 30 from a DC source. As expressed by Expression (12), the current ripple component Iᵣₚ is a function of a carrier frequency f_{c}. Accordingly, the effective value Iₑ of a phase current is a function of a carrier frequency f_{c}.

$${I}_{rp} = {I}_{c} sin 4 π {f}_{c} t \qquad ( 12 )$$

$${I}_{c} = \frac{\frac{{V}_{dc}}{3} D ( 1 - D )}{2 {f}_{c} {L}_{u}} \qquad ( 13 )$$

The carrier controller 70 calculates the amplitude Iₘ of a fundamental wave component by substituting the d-axis basic current I_{d1} and the q-axis basic current I_{q1} into Expression (11). The carrier controller 70 substitutes the amplitude Iₘ of a fundamental wave component into Expression (10) and substitutes the electrical angular velocity ωₑ into Expressions (8) to (10). Then, the carrier controller 70 calculates a carrier frequency f_{c} with which the total loss Pₐₗₗ expressed by Expression (8) is minimized. The carrier controller 70 outputs the calculated carrier frequency f_{c} to the PWM modulator 20 and the gain controller 80.

When the carrier frequency f_{c} with which the total loss Pₐₗₗ is minimized is less than a lower limit, the carrier controller 70 may set the carrier frequency f_{c} to the lower limit. For example, the lower value is half an audio frequency. When the audio frequency is 20 kHz, the lower limit is 10 kHz. When the carrier frequency f_{c} with which the total loss Pₐₗₗ is minimized is greater than an upper limit, the carrier controller 70 may set the carrier frequency f_{c} to the upper limit. For example, the upper limit is a conversion speed of the A/D converter 50 converting the output signal of the current sensor 40 to a digital value.

The gain controller 80 controls control gains which are used for first PI control, second PI control, and third PI control based on the carrier frequency f_{c}. The control gain used for first PI control includes the speed proportional gain kₛₚ and the speed integral gain kₛᵢ. The control gain used for second PI control includes the current proportional gain k_{cp} and the current integral gain k_{ci}. The current proportional gain k_{cp} includes a d-axis current proportional gain k_{dp} which is a proportional gain for the d-axis current Id and a q-axis current proportional gain k_{qp} which is a proportional gain for the q-axis current Iq. The current integral gain k_{ci} includes a d-axis current integral gain k_{di} which is an integral gain for the d-axis current Id and a q-axis current integral gain k_{qi} which is an integral gain for the q-axis current Iq. The control gain used for third PI control includes a position proportional gain kₚₚ and a position integral gain kₚᵢ.

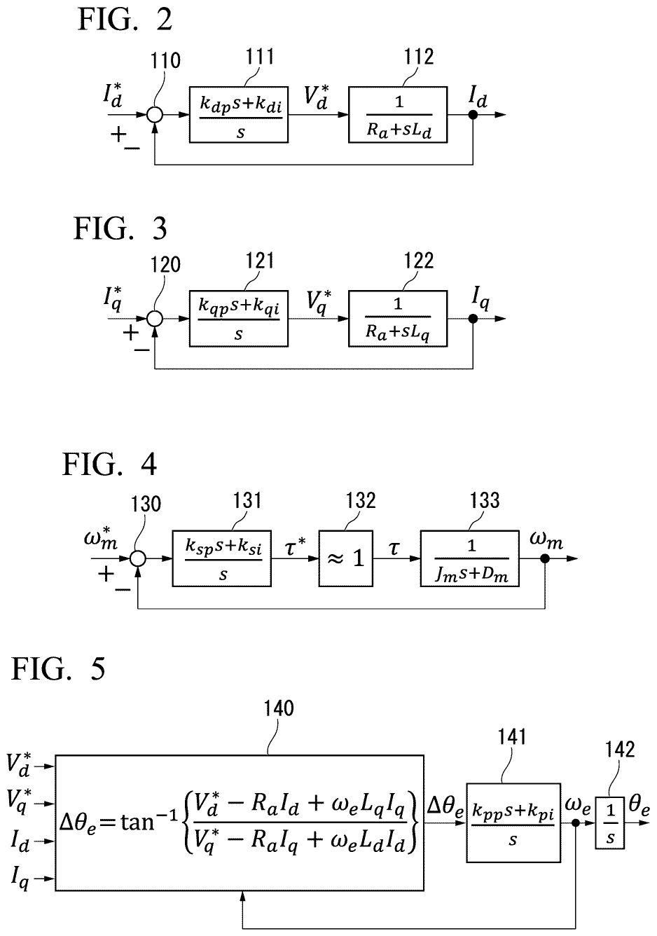

FIG. 2 is a block diagram showing an example of a current feedback control system associated with the d-axis current Id. In FIG. 2, a block 110 represents a function of calculating a difference between the d-axis current command value Id* and the d-axis current Id by subtracting the d-axis current Id from the d-axis current command value Id* out of the functions of the current controller 13. A block 111 represents a function of calculating the d-axis voltage command value Vd out of the functions of the current controller 13. Specifically, the block 111 calculates a d-axis voltage command value Vd* with which a difference between the d-axis current command value Id* and the d-axis current Id is zero based on the d-axis current proportional gain k_{dp} and the d-axis current integral gain k_{di}. A block 112 represents a system from application of the d-axis voltage command value Vd* to feedback of the d-axis current Id. When it is assumed that the d-axis current proportional gain k_{dp} is much greater than a winding resistance Rₐ of the motor 2, the d-axis current proportional gain k_{dp} is expressed by Expression (14). The d-axis current integral gain k_{di} is expressed by Expression (15). In Expressions (14) and (15), L_{d} is a d-axis inductance. ω_{ic} is a current control bandwidth. w₁ is a first constant.

$${k}_{dp} \approx {L}_{d} {ω}_{ic} ( {R}_{a} ≪ {k}_{dp} ) \qquad ( 14 )$$

$${k}_{di} \approx {L}_{d} {w}_{1} ( 1 - {w}_{1} ) {ω}_{ic}^{2} \qquad ( 15 )$$

The current control bandwidth ω_{ic} is a frequency region with which the current controller 13 can cope. For example, the gain controller 80 calculates the current control bandwidth ω_{ic} by multiplying the carrier frequency f_{c} by a predetermined coefficient having a value in a range of 0.5 to 1. The gain controller 80 calculates the d-axis current proportional gain k_{dp} by substituting the current control bandwidth ω_{ic} into Expression (14). The gain controller 80 calculates the d-axis current integral gain k_{di} by substituting the current control bandwidth ω_{ic} into Expression (15). For example, the first constant w₁ is equal to or greater than 0.05 and equal to or less than 0.3. It is preferable that the first constant w₁ be set to a greater value when responsiveness of the second PI control performed by the current controller 13 for the d-axis current Id is preferentially improved and the first constant w₁ be set to a less value when stability is preferentially improved.

FIG. 3 is a block diagram showing an example of a current feedback control system associated with the q-axis current Iq. In FIG. 3, a block 120 represents a function of calculating a difference between the q-axis current command value Iq* and the q-axis current Iq by subtracting the q-axis current Iq from the q-axis current command value Iq* out of the functions of the current controller 13. A block 121 represents a function of calculating a q-axis voltage command value Vq* out of the functions of the current controller 13. Specifically, the block 121 calculates a q-axis voltage command value Vq* with which a difference between the q-axis current command value Iq* and the q-axis current Iq is zero based on the q-axis current proportional gain k_{qp} and the q-axis current integral gain k_{qi}. A block 122 represents a system from application of the q-axis voltage command value Vq* to feedback of the q-axis current Iq. When it is assumed that the q-axis current proportional gain k_{qp} is much greater than a winding resistance Rₐ of the motor 2, the q-axis current proportional gain k_{qp} is expressed by Expression (16). The q-axis current integral gain k_{qi} is expressed by Expression (17). In Expressions (16) and (17), L_{q} is a q-axis inductance. ω_{ic} is a current control bandwidth. w₁ is a first constant.

$${k}_{qp} \approx {L}_{q} {ω}_{ic} ( {R}_{a} ≪ {k}_{qp} ) \qquad ( 16 )$$

$${k}_{qi} \approx {L}_{q} {w}_{1} ( 1 - {w}_{1} ) {ω}_{ic}^{2} \qquad ( 17 )$$

The gain controller 80 calculates the q-axis current proportional gain k_{qp} by substituting the current control bandwidth ω_{ic} into Expression (16). The gain controller 80 calculates the q-axis current integral gain k_{qi} by substituting the current control bandwidth ω_{ic} into Expression (17). For example, the first constant w₁ is equal to or greater than 0.05 and equal to or less than 0.3. It is preferable that the first constant w₁ be set to a greater value when responsiveness of the second PI control performed by the current controller 13 for the q-axis current Iq is preferentially improved and the first constant w₁ be set to a less value when stability is preferentially improved.

FIG. 4 is a block diagram showing an example of a speed feedback control system. In FIG. 4, a block 130 represents a function of calculating a difference between the angular velocity command value ω* and the machine angular velocity ωₘ by subtracting the machine angular velocity ωₘ from the angular velocity command value ω* out of the functions of the speed controller 11. A block 131 represents a function of calculating a torque command value τ* out of the functions of the speed controller 11. Specifically, the block 131 calculates a torque command value τ* with which a difference between the angular velocity command value ω* and the machine angular velocity ωₘ is zero based on the speed proportional gain kₛₚ and the speed integral gain kₛᵢ. Blocks 132 and 133 represent a system from application of the torque command value τ* to feedback of the machine angular velocity ωₘ. When it is assumed that the speed proportional gain kₛₚ is much greater than a viscosity coefficient Dₘ of the motor 2, the speed proportional gain kₛₚ is expressed by Expression (18). The speed integral gain kₛᵢ is expressed by Expression (19). In Expressions (18) and (19), Jₘ is an inertia coefficient of the motor 2. ω_{sc} is a speed control bandwidth. w₂ is a second constant.

$${k}_{sp} \approx {J}_{m} {ω}_{sc} ( {D}_{m} ≪ {k}_{sp} ) \qquad ( 18 )$$

$${k}_{si} \approx {J}_{m} {w}_{2} ( 1 - {w}_{2} ) {ω}_{sc}^{2} \qquad ( 19 )$$

The speed control bandwidth ω_{sc} is a frequency region with which the speed controller 11 can cope. For example, the gain controller 80 calculates the speed control bandwidth ω_{sc} by dividing the current control bandwidth ω_{ic} by a first integer. For example, the first integer is 5. The gain controller 80 calculates the speed proportional gain kₛₚ by substituting the speed control bandwidth ω_{sc} into Expression (18). The gain controller 80 calculates the speed integral gain kₛᵢ by substituting the speed control bandwidth ω_{sc} into Expression (19). For example, the second constant w₂ is equal to or greater than 0.05 and equal to or less than 0.5. It is preferable that the second constant w₂ be set to a greater value when responsiveness of the first PI control performed by the speed controller 11 is preferentially improved and the second constant w₂ be set to a less value when stability is preferentially improved.

For example, the position controller 16 is expressed in a block diagram shown in FIG. 5. In FIG. 5, a block 140 represents a function of calculating a rotation angle difference Δθₑ based on the d-axis voltage command value Vd*, the q-axis voltage command value Vq*, the d-axis current Id, and the q-axis current Iq out of the functions of the position controller 16. A block 141 represents a function of calculating an electrical angular velocity ωₑ at which the rotation angle difference Δθₑ is zero based on the position proportional gain kₚₚ and the position integral gain kₚᵢ out of the functions of the position controller 16. The electrical angular velocity ωₑ is fed back to the block 140. A block 142 represents a function of converting the electrical angular velocity ωₑ to the rotation angle θₑ out of the functions of the position controller 16. The position proportional gain kₚₚ is expressed by Expression (20). The position integral gain kₚᵢ is expressed by Expression (21). In Expressions (20) and (21), ω_{pc} is a position control bandwidth. w₃ is a third constant.

$${k}_{pp} \approx {ω}_{pc} \qquad ( 20 )$$

$${k}_{pi} \approx {w}_{3} ( 1 - {w}_{3} ) {ω}_{pc}^{2} \qquad ( 21 )$$

The position control bandwidth ω_{pc} is a frequency region with which the position controller 16 can cope. For example, the gain controller 80 calculates the position control bandwidth ω_{pc} by dividing the speed control bandwidth ω_{sc} by a second integer. For example, the second integer is 5. The gain controller 80 calculates the position proportional gain kₚₚ by substituting the position control bandwidth ω_{pc} into Expression (20). The gain controller 80 calculates the position integral gain kₚᵢ by substituting the position control bandwidth ω_{pc} into Expression (21). For example, the third constant w₃ is equal to or greater than 0 and equal to or less than 0.5. It is preferable that the third constant w₃ be set to a greater value when responsiveness of the third PI control performed by the position controller 16 is preferentially improved and the third constant w₃ be set to a less value when stability is preferentially improved.

The gain controller 80 outputs the calculated speed proportional gain kₛₚ and the calculated speed integral gain kₛᵢ to the speed controller 11. The gain controller 80 outputs the calculated current proportional gain k_{cp} and the calculated current integral gain k_{ci} to the current controller 13. The gain controller 80 outputs the calculated position proportional gain kₚₚ and the calculated position integral gain kₚᵢ to the position controller 16.

The gain controller 80 controls the control periods in which the first PI control, the second PI control, and the third PI control are performed based on the carrier frequency f_{c}. For example, the gain controller 80 may set to the control periods in which the first PI control, the second PI control, and the third PI control are performed to a first control period which is equal to a reciprocal of the carrier frequency f_{c}. Alternatively, the gain controller 80 may set the control periods in which the second PI control and the third PI control are performed to the first control period and set the control period in which the first PI control is performed to a second control period which is longer than the first control period. For example, the second control period is ten times the first control period.

The control device 1 according to the present embodiment includes the inverter 30 configured to covert a DC voltage to a three-phase AC voltage and to output the three-phase AC voltage to the motor 2, the PWM modulator 20 configured to generate six gate control signals for controlling six switches included in the inverter 30 based on three-phase voltage command values and carrier waves, the current sensor 40 configured to detect a current flowing in the motor 2, the vector controller 10 configured to control three-phase voltage command values such that the d-axis current Id and the q-axis current Iq match command values based on the output signal of the current sensor 40, the carrier controller 70 configured to control the carrier frequency f_{c} such that the total loss Pₐₗₗ of the loss of the inverter 30 and the loss of the motor 2 is minimized based on the d-axis current Id, the q-axis current Iq, and an electrical angular velocity ωₑ of the motor 2, and the gain controller 80 configured to control a control gain which is used for PI control performed by the vector controller 10 and a control period which is a period in which the PI control is performed based on the carrier frequency f_{c}. According to the present embodiment, since the carrier frequency f_{c} is controlled such that total loss Pₐₗₗ of the loss of the inverter 30 and the loss of the motor 2 is minimized, it is possible to control the motor 2 with maximum efficiency. Since the control gain used for PI control performed by the vector controller 10 and the control period in which the PI control is performed change according to change of the carrier frequency f_{c}, it is possible to secure responsiveness and stability of PI control performed in the vector controller 10.

In the present embodiment, the vector controller 10 includes the speed controller 11 configured to calculate a torque command value τ* with which a difference between an angular velocity command value ω* and a machine angular velocity ωₘ of the motor 2 is zero by performing first PI control, the current vector controller 12 configured to calculate a d-axis current command value Id* and a q-axis current command value Iq* based on the torque command value τ*, the current controller 13 configured to calculate a d-axis voltage command value Vd* with which a difference between the d-axis current command value Id* and the d-axis current Id is zero and a q-axis voltage command value Vq* with which a difference between the q-axis current command value Iq* and the q-axis current Iq is zero by performing second PI control, the first coordinate converter 14 configured to calculate the three-phase voltage command value by performing first coordinate conversion based on the d-axis voltage command value Vd*, the q-axis voltage command value Vq*, and a rotation angle θₑ of the motor 2, the second coordinate converter 15 configured to calculate the d-axis current Id and the q-axis current Iq by performing second coordinate conversion based on the output signal of the current sensor 40 and the rotation angle θₑ, and the position controller 16 configured to calculate the machine angular velocity ωₘ and the rotation angle θₑ by performing third PI control based on the d-axis voltage command value Vd*, the q-axis voltage command value Vq*, the d-axis current Id, and the q-axis current Iq. The gain controller 80 controls control gains which are used for the first PI control, the second PI control, and the third PI control and control periods in which the first PI control, the second PI control, and the third PI control are performed based on the carrier frequency f_{c}. According to the present embodiment, since the control gain used for the first PI control performed by the speed controller 11, the control gain used for the second PI control performed by the current controller 13, the control gain used for the third PI control performed by the position controller 16, and the control periods in which the first PI control, the second PI control, and the third PI control are performed change according to change of the carrier frequency f_{c}, it is possible to secure responsiveness and stability of the PI control performed in the vector controller 10.

In the present embodiment, the control gain used for the second PI control includes the d-axis current proportional gain k_{dp} expressed by Expression (14) and the d-axis current integral gain k_{di} expressed by Expression (15). The gain controller 80 calculates a current control bandwidth ω_{ic} by multiplying the carrier frequency f_{c} by a predetermined coefficient, calculates the d-axis current proportional gain k_{dp} by substituting the current control bandwidth ω_{ic} into Expression (14), and calculates the d-axis current integral gain k_{di} by substituting the current control bandwidth ω_{ic} into Expression (15). According to the present embodiment, it is possible to secure responsiveness and stability of the second PI control performed in the current controller 13 with good balance, particularly, in association with the d-axis current.

In the present embodiment, the control gain used for the second PI control includes the q-axis current proportional gain k_{qp} expressed by Expression (16) and the q-axis current integral gain k_{qi} expressed by Expression (17). The gain controller 80 calculates a current control bandwidth ω_{ic} by multiplying the carrier frequency f_{c} by a predetermined coefficient, calculates the q-axis current proportional gain k_{qp} by substituting the current control bandwidth ω_{ic} into Expression (16), and calculates the q-axis current integral gain k_{qi} by substituting the current control bandwidth ω_{ic} into Expression (17). According to the present embodiment, it is possible to secure responsiveness and stability of the second PI control performed in the current controller 13 with good balance, particularly, in association with the q-axis current.

In the present embodiment, the control gain used for the first PI control includes a speed proportional gain kₛₚ expressed by Expression (18) and a speed integral gain kₛᵢ expressed by Expression (19). The gain controller 80 calculates a speed control bandwidth ω_{sc} by dividing the current control bandwidth ω_{ic} by a first integer, calculates the speed proportional gain kₛₚ by substituting the speed control bandwidth ω_{sc} into Expression (18), and calculates the speed integral gain kₛᵢ by substituting the speed control bandwidth ω_{sc} into Expression (19). According to the present embodiment, it is possible to secure responsiveness and stability of the first PI control performed in the speed controller 11 with good balance.

In the present embodiment, the control gain used for the third PI control includes a position proportional gain kₚₚ expressed by Expression (20) and a position integral gain kₚᵢ expressed by Expression (21). The gain controller 80 calculates a position control bandwidth ω_{pc} by dividing the speed control bandwidth ω_{sc} by a second integer, calculates the position proportional gain kₚₚ by substituting the position control bandwidth ω_{pc} into Expression (20), and calculates the position integral gain kₚᵢ by substituting the position control bandwidth ω_{pc} into Expression (21). According to the present embodiment, it is possible to secure responsiveness and stability of the third PI control performed in the position controller 16 with good balance.

In the present embodiment, the gain controller 80 sets the control periods in which the first PI control, the second PI control, and the third PI control are performed to a first control period which is equal to a reciprocal of the carrier frequency f_{c} or sets the control periods in which the second PI control and the third PI control are performed to the first control period and sets the control period in which the first PI control is performed to a second control period which is longer than the first control period. According to the present embodiment, it is possible to secure responsiveness and stability of the PI control performed in the vector controller 10.

In the present embodiment, when the carrier frequency f_{c} with which the total loss Pₐₗₗ is minimized is less than a lower limit, the carrier controller 70 sets the carrier frequency f_{c} to the lower limit. The lower limit is half an audio frequency. Since noise occurs at a frequency which doubles the carrier frequency f_{c}, it is possible to curb noise occurring due to the carrier frequency f_{c} by setting the lower limit of the carrier frequency f_{c} to half the audio frequency.

In the present embodiment, when the carrier frequency f_{c} with which the total loss Pₐₗₗ is minimized is greater than an upper limit, the carrier controller 70 sets the carrier frequency f_{c} to the upper limit. The upper limit is a conversion speed of the A/D converter 50 configured to cover the output signal of the current sensor 40 to a digital value. When the carrier frequency f_{c} is greater than the conversion speed of the A/D converter 50, it is difficult to perform vector control normally. Accordingly, it is possible to curb occurrence of an abnormality in vector control by setting the upper limit of the carrier frequency f_{c} to the conversion speed of the A/D converter 50.

The control device 1 according to the present embodiment further includes the LPD 60 configured to extract fundamental wave components of the d-axis current Id and the q-axis current Iq. The carrier controller 70 controls the carrier frequency f_{c} such that the total loss Pₐₗₗ is minimized based on the fundamental wave components of the d-axis current Id and the q-axis current Iq and the electrical angular velocity ωₑ. According to the present embodiment, it is possible to curb vibration and oscillation occurring due to change of the carrier frequency f_{c}.

In the present embodiment, the loss of the inverter 30 includes an on-resistance loss Pₒₙ, a switching loss P_{sw}, a shunt-resistance loss Pₛₕ, a gate-charge loss P_{gate}, and a dead-time loss P_{dead}. The loss of the motor 2 includes a copper loss W_{c} and an iron loss Wᵢ. According to the present embodiment, since the total loss Pₐₗₗ of the loss of the inverter 30 and the loss of the motor 2 becomes a more accurate value, it is possible to control the motor 2 with higher efficiency.

According to at least one embodiment described above, the control device includes an inverter configured to convert a DC voltage to an AC voltage and to output the AC voltage to a motor, a modulator configured to generate a pulse width modulation signal for controlling switches included in the inverter based on a phase voltage command value and a carrier wave, a current sensor configured to detect a current flowing in the motor, a vector controller configured to control the phase voltage command value such that a d-axis current and a q-axis current match a command value based on an output signal of the current sensor, a carrier controller configured to control a carrier frequency which is a frequency of the carrier waves such that a total loss of a loss of the inverter and a loss of the motor is minimized based on the d-axis current, the q-axis current, and an electrical angular velocity of the motor, and a gain controller configured to control a control gain which is used in PI control performed by the vector controller and a control period which is a period in which the PI control is performed based on the carrier frequency. Accordingly, it is possible to provide a control device that can control a motor with maximum efficiency.

The functionality of the elements disclosed herein may be implemented using circuitry or processing circuitry which includes general purpose processors, special purpose processors, integrated circuits, ASICs, FPGAs, conventional circuitry and/or combinations thereof which are programmed, using one or more programs stored in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control device that controls a motor, the control device comprising:
an inverter configured to convert a DC voltage to an AC voltage and to output the AC voltage to the motor;
a modulator configured to generate a pulse width modulation signal for controlling switches included in the inverter based on a phase voltage command value and a carrier wave;
a current sensor configured to detect a current flowing in the motor;
a vector controller configured to control the phase voltage command value such that a d-axis current and a q-axis current match a command value based on an output signal of the current sensor;
a carrier controller configured to control a carrier frequency which is a frequency of the carrier waves such that a total loss of a loss of the inverter and a loss of the motor is minimized based on the d-axis current, the q-axis current, and an electrical angular velocity of the motor; and
a gain controller configured to control a control gain which is used in PI control performed by the vector controller and a control period which is a period in which the PI control is performed based on the carrier frequency.

2. The control device according to claim 1, wherein the vector controller includes:
a velocity controller configured to calculate a torque command value with which a difference between an angular velocity command value and a machine angular velocity of the motor is zero by performing first PI control;
a current vector controller configured to calculate a d-axis current command value and a q-axis current command value based on the torque command value;
a current controller configured to calculate a d-axis voltage command value with which a difference between the d-axis current command value and the d-axis current is zero and a q-axis voltage command value with which a difference between the q-axis current command value and the q-axis current is zero by performing second PI control;
a first coordinate converter configured to calculate the phase voltage command value by performing first coordinate conversion based on the d-axis voltage command value, the q-axis voltage command value, and a rotation angle of the motor;
a second coordinate converter configured to calculate the d-axis current and the q-axis current by performing second coordinate conversion based on the output signal of the current sensor and the rotation angle; and
a position controller configured to calculate the machine angular velocity and the rotation angle by performing third PI control based on the d-axis voltage command value, the q-axis voltage command value, the d-axis current, and the q-axis current, and
wherein the gain controller controls control gains which are used for the first PI control, the second PI control, and the third PI control and control periods in which the first PI control, the second PI control, and the third PI control are performed based on the carrier frequency.

3. The control device according to claim 2, wherein the control gain used for the second PI control includes a d-axis current proportional gain k_{dp} expressed by Expression (14) and a d-axis current integral gain k_{di} expressed by Expression (15), and
wherein the gain controller performs:
calculating a current control bandwidth ω_{ic} by multiplying the carrier frequency by a predetermined coefficient;
calculating the d-axis current proportional gain k_{dp} by substituting the current control bandwidth ω_{ic} into Expression (14); and
calculating the d-axis current integral gain k_{di} by substituting the current control bandwidth ω_{ic} into Expression (15),
$${k}_{dp} \approx {L}_{d} {ω}_{ic} ( {R}_{a} ≪ {k}_{dp} ) \qquad ( 14 )$$
$${k}_{di} \approx {L}_{d} {w}_{1} ( 1 - {w}_{1} ) {ω}_{ic}^{2} \qquad ( 15 )$$

4. The control device according to claim 2, wherein the control gain used for the second PI control includes a q-axis current proportional gain k_{qp} expressed by Expression (16) and a q-axis current integral gain k_{qi} expressed by Expression (17), and
wherein the gain controller performs:
calculating a current control bandwidth ω_{ic} by multiplying the carrier frequency by a predetermined coefficient;
calculating the q-axis current proportional gain k_{qp} by substituting the current control bandwidth ω_{ic} into Expression (16); and
calculating the q-axis current integral gain k_{qi} by substituting the current control bandwidth ω_{ic} into Expression (17),
$${k}_{qp} \approx {L}_{q} {ω}_{ic} ( {R}_{a} ≪ {k}_{qp} ) \qquad ( 16 )$$
$${k}_{qi} \approx {L}_{q} {w}_{1} ( 1 - {w}_{1} ) {ω}_{ic}^{2} \qquad ( 17 )$$

5. The control device according to claim 3, wherein the control gain used for the first PI control includes a speed proportional gain kₛₚ expressed by Expression (18) and a speed integral gain kₛᵢ expressed by Expression (19), and
wherein the gain controller performs:
calculating a speed control bandwidth ω_{sc} by dividing the current control bandwidth ω_{ic} by a first integer;
calculating the speed proportional gain kₛₚ by substituting the speed control bandwidth ω_{sc} into Expression (18); and
calculating the speed integral gain kₛᵢ by substituting the speed control bandwidth ω_{sc} into Expression (19),
$${k}_{sp} \approx {J}_{m} {ω}_{sc} ( {D}_{m} ≪ {k}_{sp} ) \qquad ( 18 )$$
$${k}_{si} \approx {J}_{m} {w}_{2} ( 1 - {w}_{2} ) {ω}_{sc}^{2} \qquad ( 19 )$$

6. The control device according to claim 5, wherein the control gain used for the third PI control includes a position proportional gain kₚₚ expressed by Expression (20) and a position integral gain kₚᵢ expressed by Expression (21), and
wherein the gain controller performs:
calculating a position control bandwidth ω_{pc} by dividing the speed control bandwidth ω_{sc} by a second integer;
calculating the position proportional gain kₚₚ by substituting the position control bandwidth ω_{pc} into Expression (20); and
calculating the position integral gain kₚᵢ by substituting the position control bandwidth ω_{pc} into Expression (21),
$${k}_{pp} \approx {ω}_{pc} \qquad ( 20 )$$
$${k}_{pi} \approx {w}_{3} ( 1 - {w}_{3} ) {ω}_{pc}^{2} \qquad ( 21 )$$

7. The control device according to claim 2, wherein the gain controller performs:
setting the control periods in which the first PI control, the second PI control, and the third PI control are performed to a first control period which is equal to a reciprocal of the carrier frequency, or
setting the control periods in which the second PI control and the third PI control are performed to the first control period and setting the control period in which the first PI control is performed to a second control period which is longer than the first control period.

8. The control device according to claim 1, wherein the carrier controller sets the carrier frequency to a lower limit when the carrier frequency with which the total loss is minimized is less than the lower limit, and
wherein the lower limit is half an audio frequency.

9. The control device according to claim 1, wherein the carrier controller sets the carrier frequency to an upper limit when the carrier frequency with which the total loss is minimized is greater than the upper limit, and
wherein the upper limit is a conversion speed of an A/D converter configured to convert the output signal of the current sensor to a digital value.

10. The control device according to claim 1, further comprising a low-pass filter configured to extract fundamental wave components of the d-axis current and the q-axis current,
wherein the carrier controller controls the carrier frequency such that the total loss is minimized based on the fundamental wave components of the d-axis current and the q-axis current and the electrical angular velocity.

11. The control device according to claim 1, wherein the loss of the inverter includes an on-resistance loss, a switching loss, a shunt-resistance loss, a gate-charge loss, and a dead-time loss, and
wherein the loss of the motor includes a copper loss and an iron loss.
